(19) United States
(12) Patent Application Publication
(10) Pub. No.: US 2018/0230757 A1
(43) Pub. Date: Aug. 16, 2018

(54) Set Screw Anti-Rotation Device with Knurl Surface

(71) Applicant: Dril-Quip, Inc., Houston, TX (US)

(72) Inventors: John E. Nelson, Houston, TX (US); Christopher C. Mayer, Houston, TX (US); Flavio E. Santos, Houston, TX (US)

(21) Appl. No.: 15/429,381

(22) Filed: Feb. 10, 2017

(51) Int. Cl. E21B 17/043; E21B 19/16; F16L 15/08

(52) U.S. Cl. CPC E21B 17/043; F16L 15/08; E21B 19/16

(57) ABSTRACT

In accordance with embodiments of the present disclosure, a system includes a first tubular member having a first knurl surface and a second tubular member having a recessed slot located in the inner circumference of the second tubular member and a threaded hole from the external circumference of the second tubular member into the recessed slot. The system may further include an insert located within the recessed slot, the insert comprising a second knurl surface facing radially inward from the second tubular member and a set screw within the threaded hole of the second tubular member, the set screw having an unthreaded end mechanically coupled to the insert. The set screw rotatable to drive the second knurl surface of the insert into the first knurl surface of the first tubular member.

### TECHNICAL FIELD

The present disclosure relates generally to connector assemblies and, more particularly, to a set screw anti-rotation device with knurl surface.

### BACKGROUND

Offshore oil and gas drilling operations typically include the make-up of strings of pipe or casing members, frequently of relatively large diameter. The string of tubular members may be driven into the ground underwater to be used for anchoring the drilling platform. Such strings are also used as conduits in the water through which a well may be initiated. The joint between members of such tubular strings must provide both structural strength and fluid pressure integrity. Such features of a joint might be provided, for example, by welding. However, because welding is a time-consuming operation, and drilling rig rates are high, particularly offshore, mechanical connectors are generally preferred. Typical mechanical connectors available include threaded type connectors in which tubular members are mutually rotated to thread a pin and box connector assembly, breach block connectors, and snap lock connectors.

In threaded mechanical connector assemblies an externally threaded end, known as the pin, mates with an internally threaded section, known as the box. The pin and the box on a threaded connector assembly are designed to be engaged with each other and rotated to a specific torque value for connecting the ends. After the connection is made, anti-rotation devices can be installed to secure the pin and the box together at the desired make-up torque. The anti-rotation devices are designed to ensure that the threaded portions of the connector assembly do not become tightened over the desired make-up torque or loosened from each other in response to forces applied to the pipe or casing members in the string.

Existing anti-rotation devices often feature a mechanical key that can be selectively positioned in a recess between the pin and the box of the connector assembly to prevent rotation of the pin and the box relative to each other in a certain direction once the make-up torque is reached. Unfortunately, these keys typically do not go into action to engage with the connector assembly until after the connection is loosened slightly. That is, the keys are generally first positioned in the recesses of the connector assembly, and then the pin and box are rotated slightly relative to each other to energize the key. As a result, the connection may be secured at a different torque than the initial desired make-up torque.

In addition, some existing anti-rotation keys are designed to interface very closely with the connector assembly to fill a recess therein. As such, these keys can be difficult to position in the corresponding recess and often must be hammered into engagement with the connector assembly using a large amount of force. This hammering process takes an undesirable amount of time and energy to ensure that the keys are lodged into their respective recesses in the connector assembly.

### SUMMARY OF THE DISCLOSURE

In one embodiment, a radial set screw anti-rotation device includes an insert located within a recessed slot of a first tubular member, the recessed slot located in the inner circumference of the first tubular member and the insert having a first knurl surface facing radially inward from the first tubular member. The radial set screw anti-rotation device may also include a set screw located within a threaded hole of the first tubular member, the threaded hole extending from the external circumference of the first tubular member into the recessed slot, wherein the set screw comprises an unthreaded end mechanically coupled to the insert. The set screw may be rotatable to drive the first knurl surface of the insert into a second knurl surface of a second tubular member, when the first tubular member and the second tubular member are coupled.

In an example embodiment, a method for coupling tubular members includes preparing a first tubular member and a second tubular member to receive a radial set screw anti-rotation device. Preparing the first tubular member and the second tubular member further includes, milling a recessed slot in the inner circumference of the second tubular member, drilling a hole from the external circumference of the second tubular member into the recessed slot, and tapping the hole from the external circumference of the second tubular member into the recessed slot. The method may further include assembling the radial set screw anti-rotation device. Assembling the radial set screw anti-rotation device includes installing an insert within the recessed slot of the second tubular member, the insert comprising a first knurl surface facing radially inward from the second tubular member and threading a set screw within the threaded hole of the second tubular member, the set screw having an unthreaded end mechanically coupled to the insert. The method may then include coupling the first tubular member and the second tubular member to a make-up torque. The method may then include driving the first knurl surface of the insert into a second knurl surface of the first tubular device by rotating the insert within the tapped hole.

Technical advantages of certain embodiments may include minimizing damage to the load shoulder of the tubular members when the tubular members are decoupled. Another advantage provided by certain embodiments minimizes the labor needed to couple tubular members using the anti-rotation device by not requiring drilling during installation of the anti-rotation apparatus while coupling the tubular members.

Other technical advantages will be readily apparent to one skilled in the art from FIGS. 1-5, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a cross sectional view of a connector assembly comprising a female tubular member and a male tubular member having a radial set screw anti-rotation device, in accordance with an embodiment of the present disclosure;

FIG. 2 illustrates a cross-section view of the radial set screw anti-rotation device with a knurl surface, in accordance with an embodiment of the present disclosure;

FIG. 3 illustrates a cross sectional view of a connector assembly comprising a vertical set screw anti-rotation device, in accordance with an embodiment of the present disclosure;

FIG. 4A illustrates a cross-section view of the vertical set screw anti-rotation device within the connector assembly, in accordance with an embodiment of the present disclosure;

FIG. 4B illustrates a close-up, cross-section view of the vertical set screw anti-rotation device, in accordance with an embodiment of the present disclosure; and

FIG. 5 illustrates a method for securely coupling tubular members using a set screw anti-rotation device with a knurl surface, in accordance with an embodiment of the present disclosure.

### DETAILED DESCRIPTION

Certain embodiments according to the present disclosure may be directed to a set screw anti-rotation device with knurl surface designed to prevent rotation of a first threaded tubular member of a connector assembly with respect to a second threaded tubular member of the connector assembly. The set screw anti-rotation device includes several features that facilitate easier, faster, and more accurate securing of the tubular members to prevent rotation of the threaded tubular members of the connector. For example, the set screw anti-rotation device may include features that prevent decoupling of the threaded tubular members once the desired torque is applied to the threaded tubular members.

As explained in greater detail below, in certain embodiments a radial set screw anti-rotation device with knurl surface may prevent two tubular members from rotating once coupled. To implement the radial set screw anti-rotation device with knurl surface, the inner circumference of a female tubular member may include a recessed slot. A threaded hole may then extend from the external circumference of the female tubular, through its wall, and into the recessed slot. An insert having a radially inward facing straight knurl surface may then be placed within the recessed slot. A set screw may be inserted into the threaded hole and fastened to the insert. For example, in some embodiments the insert has a hole through which an unthreaded portion of the set screw may extend. A washer and a retaining ring may be placed around the portion of the set screw extending through the insert to mechanically couple the set screw to the insert. In this manner, the set screw may be rotated within the threaded hole to move the insert radially back and forth.

Once the radial set screw anti-rotation device is assembled, the female tubular member may be coupled with a male tubular member. The male tubular member may also have a straight knurl outer surface. After applying the desired torque to the tubular members, the set screw may be rotated to drive the straight knurl surface of the insert radially into the straight knurl surface of the male tubular member, thereby preventing further rotation of the threaded tubular members. To disconnect or re-torque the tubular members, the set screw may be rotated in the opposite direction to remove the straight knurl surface of the insert from the straight knurl surface of the male tubular member.

As another example of a set screw anti-rotation device, according to certain embodiments a vertical set screw anti-rotation device with knurl surface may prevent two tubular members from de-coupling and/or becoming over torqued once coupled. To implement the vertical set screw anti-rotation device with knurl surface, the bottom shoulder of a male tubular member may include a blind hole that extends vertically up into the male tubular member. The top of the shoulder of the male tubular member may also include a vertical threaded hole that breaks into the blind hole. A set screw may be inserted into the threaded hole and fastened to a gripper having a straight knurl surface. In some embodiments, the set screw is fastened to the gripper using a socket head cap screw that extends through the set screw and into the gripper. The vertical set screw anti-rotation device may also include an insert having a straight knurl surface that is fitted into a slot milled on the top face of a female tubular member.

Once the vertical set screw anti-rotation device is assembled, the female tubular member may be coupled with the male tubular member. After applying the desired torque to the tubular members, the vertical set screw may be rotated to drive the straight knurl surface of the gripper vertically into the straight knurl surface of the insert, thereby preventing further rotation of the threaded tubular members. To disconnect or re-torque the tubular members, the vertical set screw may be rotated in the opposite direction to remove the straight knurl surface of the gripper from the straight knurl surface of the insert.

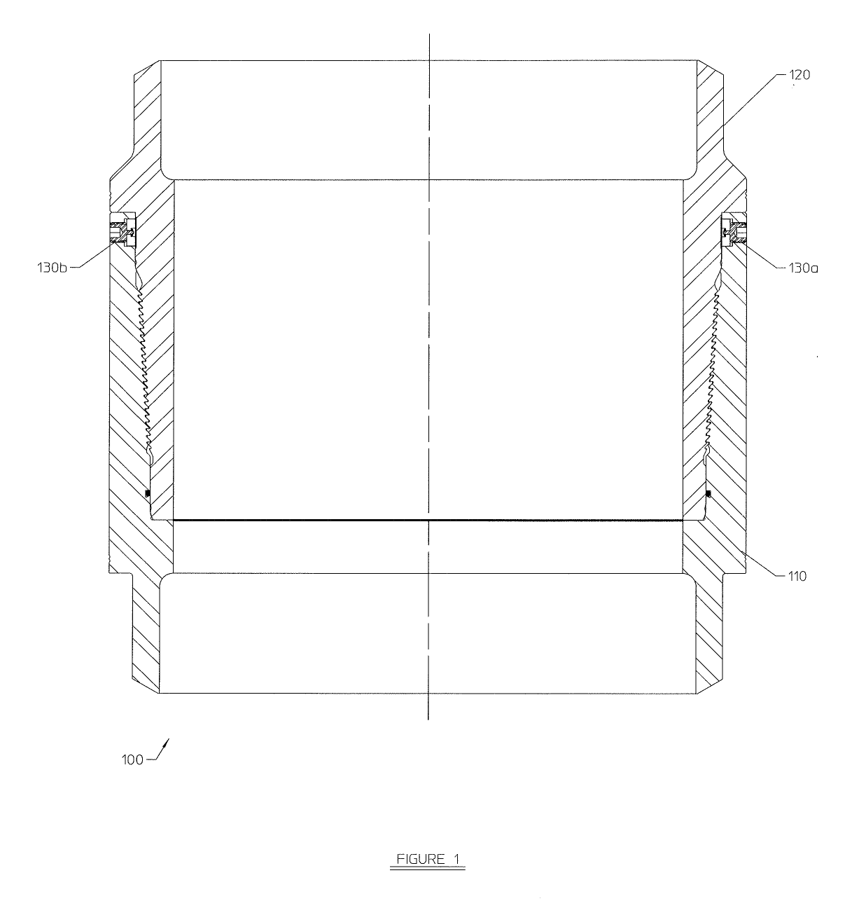

Accordingly, the foregoing method used for the set screw anti-rotation device with knurl surface does not involve rotating the threaded portions of the tubular members relative to each other to energize a key, such as those used in existing systems. Instead, the installation method may enable the set screw anti-rotation device to be positioned directly through the connector assembly with little or no clearance gap formed by rotating the threaded portions relative to each other. That is, the set screw anti-rotation device is driven through the connector assembly in a way that reduces, minimizes, or eliminates any rotational clearance gap from the proper make-up torque for the connection of the tubular members. FIGS. 1-5 provide additional details of a set screw anti-rotation device with knurl surface.

FIG. 1 illustrates a cross sectional view of a connector assembly 100 comprising a female tubular member 110 and a male tubular member 120 having a radial set screw anti-rotation device 130. Female tubular member 110 may have internal threads, while male tubular member 120 may have external threads. In certain applications, female tubular member 110 may be referred to as the “box” and male tubular member 120 may be referred to as the “pin.” The box and pin are designed to be coupled together. These tubular members may include, for example, lengths of a wire stem or large diameter casing.

In some embodiments, the pin is formed into the first tubular component and the box is formed into the second tubular component, such that the connector assembly 100 is integral to the tubular components being connected. In other embodiments, the pin and the box may be separate components that are attached to their respective tubular components as desired to facilitate the connection. However, the present disclosure is not limited to any specific configuration of the pin and box relative to the female tubular member 110 and the male tubular member 120 being connected.

When coupling female tubular member 110 with male tubular member 120, it is desirable to rotate the first and second tubular members relative to each other until the tubular members reach a desired make-up torque. Upon reaching this make-up torque, the tubular members may be secured using one or more radial set screw anti-rotation devices 130a and 130b (collectively “radial set screw anti-rotation devices 130”) to prevent female tubular member 110 and male tubular member 120 from rotating out of their designated make-up torque. As illustrated in FIG. 1, connector assembly 100 may include multiple radial set screw anti-rotation devices 130 about a circumference of connector assembly 100. Radial set screw anti-rotation device 130 may ensure that a secure connection is formed around the entire boundary between female tubular member 110 and male tubular member 120. Although FIG. 1 is illustrated as having radial set screw anti-rotation devices 130a and 130b, any number of radial set screw anti-rotation devices 130 may be used in connector assembly 100.

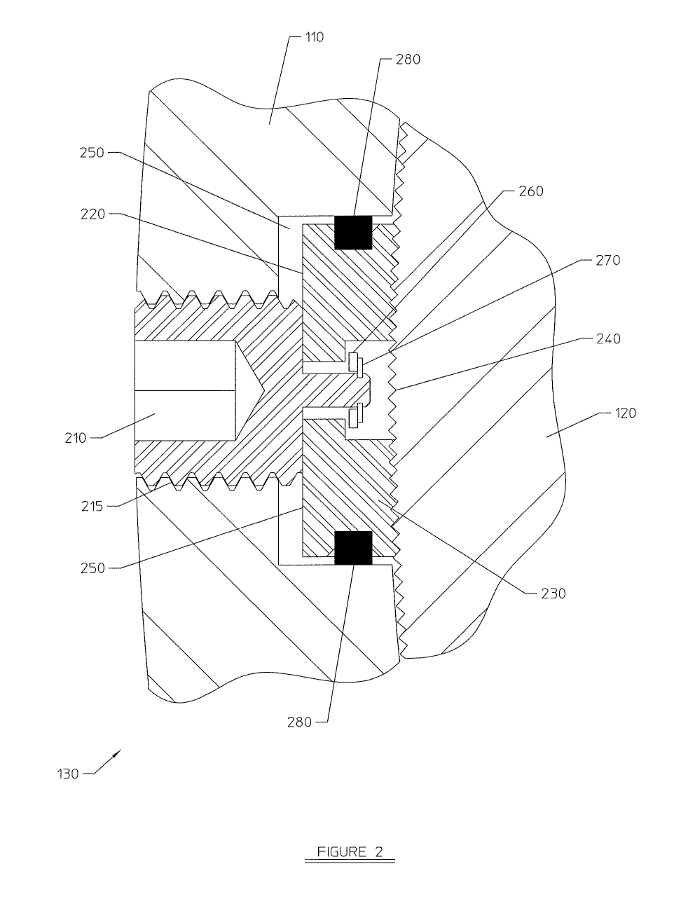

FIG. 2 illustrates a cross-section view of radial set screw anti-rotation device 130 with knurl surface 230. In the illustrated embodiment, the inner circumference of female tubular member 110 has a recessed slot 250 and a radial threaded hole 215 extending from the outer circumference of female tubular member 110 into recessed slot 250.

Radial set screw anti-rotation device 130 may be assembled within female tubular member 110 prior to coupling with male tubular member 120. An insert 220 having a radially inward facing knurl surface 230 may be fitted into recessed slot 250. Insert 220 may be any suitable size, shape, and material that allows insert 220 to prevent the rotation of female tubular member 110 and male tubular member 120. For example, in certain embodiments, insert 220 may be made of a synthetic polymer such as nylon. In some embodiments, recessed slot 250 is milled to have a clearance that allows insert 220 to move one-half tooth of the straight knurl pattern in either direction.

In certain embodiments, cord stock 280 may also be placed in between the walls of recessed slot 250 and insert 220. Cord stock 280 may act as a centralizing member on insert 220. Cord stock 280 may be made of any suitable material (e.g., Buna'n, Neoprene, Ethylene, Silicone) that is capable of centering insert 220 within recessed slot 250. In some embodiments, cord stock 280 may be O-ring cord stock.

Once insert 220 is fixed within recessed slot 250, a radial set screw 210 may be inserted into radial threaded hole 215 and coupled to insert 220. Radial set screw 210 may be coupled to insert 220 in any suitable manner. For example, in the illustrated embodiment, insert 220 comprises two flat sections with a gap in the middle. Radial set screw 210 may have an unthreaded end that extends through the gap in insert 220. For example, radial set screw 210 may be an extended point set screw (i.e., a dog or pilot point set screw). As further shown in FIG. 2, a washer 260 and a retaining ring 270 may then be attached to the portion of radial set screw 210 extending through insert 220. Thus, in certain embodiments, radial set screw anti-rotation device 130 may comprise radial set screw 210 mechanically coupled to insert 220. Assembling radial set screw anti-rotation device 130 in this manner, allows radial set screw 210 to be rotated thereby moving insert 220 in the radial direction.

Male tubular member 120 may have a knurl outer surface 240. In some embodiments, knurl outer surface 240 may extend around the entire circumference (i.e., 360 degrees) of male tubular member 120. Alternatively, knurl outer surface 240 may be applied to a limited portion of the circumference of male tubular member 120.

Once radial set screw anti-rotation device 130 is assembled, female tubular member 110 and male tubular member 120 may be coupled together until reaching a desired make-up torque. Upon reaching this make-up torque, radial set screw 210 may be rotated causing insert 220 to drive into knurl outer surface 240. In some embodiments, an Allen wrench may be used to rotate radial set screw 210 from outside female tubular member 110. In this manner, knurl surface 230 of insert 220 will grip into knurl outer surface 240 of male tubular member 120 preventing the rotation of connector assembly 100.

The knurl pattern of radially inward facing knurl surface 230 and knurl outer surface 240 of male tubular member 120 may be any suitable knurled or profiled surface that is operable to resist movement in a single direction between male tubular member 120 and female tubular member 110 when insert 220 is driven into knurl outer surface 240.

If female tubular member 110 and male tubular member 120 are to be de-coupled or a different torque is to be applied, radial set screw 210 may be rotated in the opposite direction thereby removing knurl surface 230 of insert 220 from knurl outer surface 240 of male tubular member 120. Female tubular member 110 and male tubular member 120 may then rotate as needed.

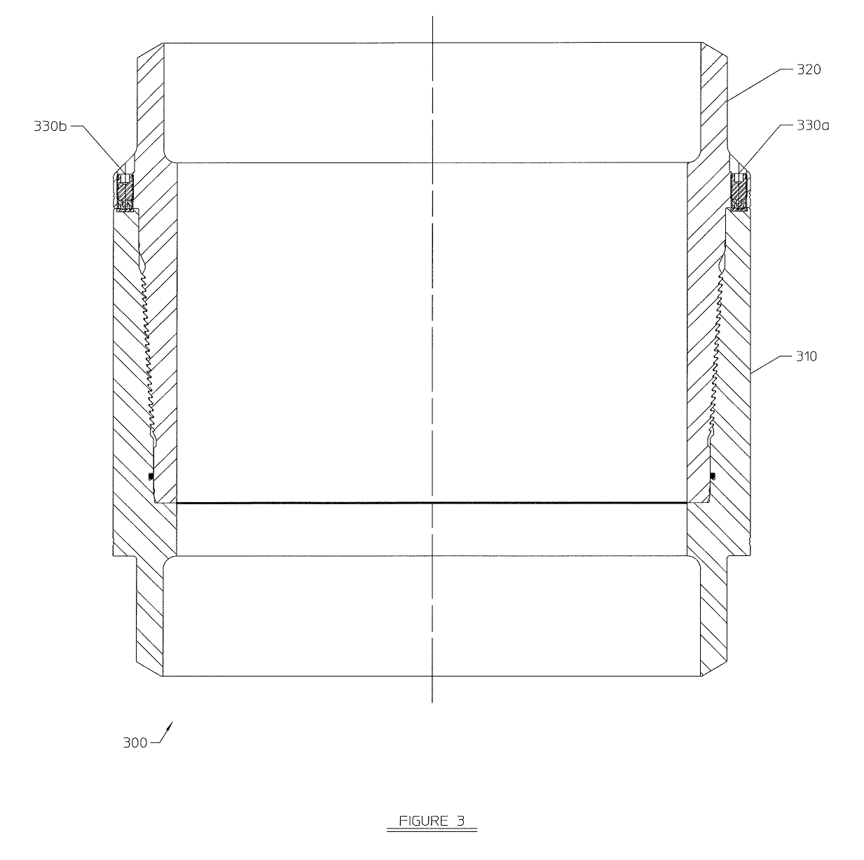

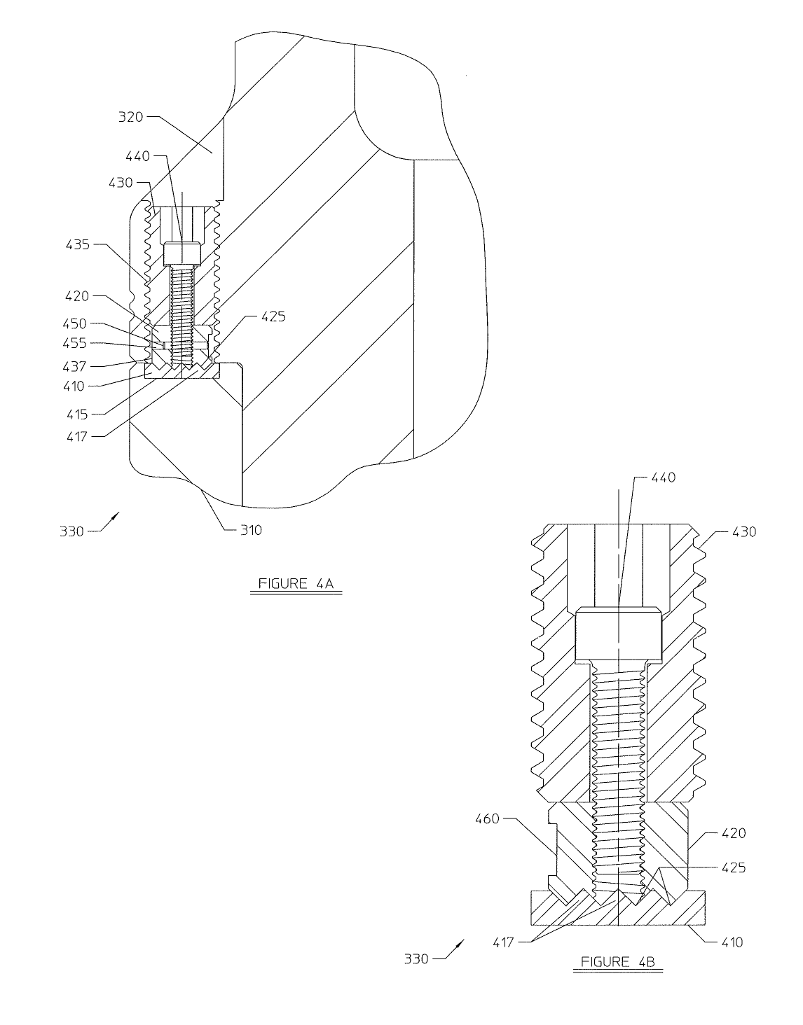

Modifications, additions, or omissions may be made to the system illustrated as connector assembly 100 without departing from the scope of the disclosure. For example, in other embodiments the pin and the box sections of the connector assembly 100 may be reversed, such that the box acts as the male tubular member and the pin acts as the female tubular member. Furthermore, as explained in greater detail with respect to FIGS. 3 and 4, the design of female tubular member 110 and male tubular member 120 may allow for different layout and configurations of set screw anti-rotation device. As another example, although male tubular member 120 is illustrated having knurl outer surface 240, in some embodiments, male tubular member 120 may have a milled recessed area for receiving an insert having a knurl surface.

FIG. 3 illustrates a cross sectional view of connector assembly 300 comprising a vertical set screw anti-rotation device 330. Connector assembly 300 comprises female tubular member 310, male tubular member 320 and vertical set screw anti-rotation device 330. In contrast to FIG. 1, vertical set screw anti-rotation device 330 is located vertically within the shoulder of male tubular member 320, instead of radially within female tubular member 110. Analogous to the tubular members described in FIG. 1, in some embodiments, female tubular member 310 may have internal threads, while male tubular member 320 may have external threads. Similarly, female tubular member 310 may be referred to as the “box” and male tubular member 320 may be referred to as the “pin.”

When coupling female tubular member 310 with male tubular member 320, it is desirable to rotate the first and second threaded portions relative to each other until the tubular members reach a desired make-up torque. Upon reaching this make-up torque, the tubular members may be secured using one or more vertical set screw anti-rotation devices 330a and 330b (collectively “vertical set screw anti-rotation devices 330”) to prevent female tubular member 310 and male tubular member 320 from rotating out of their designated make-up torque. As illustrated in FIG. 3, connector assembly 300 may include multiple vertical set screw anti-rotation devices 330 about a circumference of connector assembly 300, to ensure a secure connection around the entire boundary between female tubular member 310 and male tubular member 320. Although FIG. 3 is illustrated as having vertical set screw anti-rotation devices 330a and 330b, any number of vertical set screw anti-rotation devices 330 may be used in connector assembly 300.

FIG. 4A illustrates a cross-section view of the vertical set screw anti-rotation device 330 within connector assembly 300. In the illustrated embodiment, male tubular member 320 includes a blind hole 437 extending up from the bottom shoulder of male tubular member 320. The top shoulder of male tubular member 320 may include a vertical threaded hole 435 that extends into blind hole 437 located on the bottom of the shoulder of male tubular member 320. Female tubular member 310 includes a vertical recessed slot 415 on the top face of female tubular member 310.

Vertical set screw anti-rotation device 330 may be assembled within female tubular member 310 and male tubular member 320 prior to coupling of tubular members 310 and 320. For example, vertical knurl insert 410 may be placed within vertical recessed slot 415. In the illustrated embodiment, vertical knurl insert 410 has a vertical knurl surface 417 facing male tubular member 320. Vertical knurl surface 417 may have any suitable pattern or dimensions. For instance, vertical knurl surface 417 may comprise a straight knurl pattern. Vertical knurl insert 410 may be any suitable size, shape, and material that allows vertical knurl insert 410 to prevent the rotation of female tubular member 310 and male tubular member 320. For example, in certain embodiments, vertical knurl insert 410 may be made of a synthetic polymer such as nylon. In some embodiments, vertical recessed slot 415 is milled to have a clearance in the circumferential direction that allows vertical knurl insert 410 to move one-half tooth of the straight knurl pattern in either direction.

Within male tubular member 320, vertical set screw 430 may be coupled to gripper 420. To couple vertical set screw 430 to gripper 420, vertical set screw 430 may be threaded into vertical threaded hole 435. A socket head cap screw 440 may be inserted into vertical set screw 430 and extend into blind hole 437. A gripper 420 may be inserted through the bottom of the load shoulder of male tubular member 320 into blind hole 437. Socket head cap screw 440 may then be threaded into gripper 420, thereby mechanically coupling gripper 420 to vertical set screw 430.

Gripper 420 may include gripper knurl surface 425 facing vertically towards female tubular member 310. Gripper knurl surface 425 may have any suitable pattern or dimensions. For instance, gripper knurl surface 425 may comprise a straight knurl pattern. In some embodiments, a pin 450 may be inserted through pin hole 455 to prevent gripper 420 from rotating within blind hole 437. Gripper 420 may be made of any suitable material and any suitable shape that prevents female tubular member 310 and male tubular member 320 from rotating when gripper 420 is engaged with vertical knurl insert 410. For example, in some embodiments, gripper 420 may be made of metal, metal alloy, plastic, synthetic polymer, or any other suitable material.

Once vertical set screw anti-rotation device 330 is assembled, female tubular member 310 and male tubular member 320 may be coupled together until reaching a desired make-up torque. Upon reaching this make-up torque, vertical set screw 430 may be rotated causing gripper 420 to drive into vertical knurl insert 410. In some embodiments, an Allen wrench may be used to rotate vertical set screw 430 from outside male tubular member 320. In this manner, gripper knurl surface 425 of gripper 420 may lock into vertical knurl surface 417 of vertical knurl insert 410, thereby preventing the rotation of connector assembly 300.

If female tubular member 310 and male tubular member 320 are to be de-coupled or a different torque is to be applied, vertical set screw 430 may be rotated in the opposite direction thereby removing gripper knurl surface 425 of gripper 420 from vertical knurl surface 417 of vertical knurl insert 410. Female tubular member 310 and male tubular member 320 may then rotate as needed.

FIG. 4B illustrates a close-up, cross-section view of the vertical set screw anti-rotation device 330. In the illustrated embodiment, vertical set screw 430 is mechanically coupled to gripper 420 using socket head cap screw 440. Gripper 420 may be internally threaded to allow socket head cap screw 440 to thread into gripper 420. Thus, in some embodiments, socket head cap screw 440 may be inserted into vertical set screw 430 and extend through the base of vertical set screw 430. Socket head cap screw 440 may then be threaded into gripper 420, thereby mechanically coupling gripper 420 to vertical set screw 430.

In some embodiments, gripper 420 may include gripper pin slot 460. Gripper pin slot 460 may allow pin 450 to be inserted through pin hole 455 within male tubular member 320 to prevent gripper 420 from rotating when vertical set screw 430 is rotated.

The illustrated embodiment further shows vertical knurl surface 417 of vertical knurl insert 410 and gripper knurl surface 425 of gripper 420. As shown in FIG. 4A, once female tubular member 310 and male tubular member 320 are coupled to a desired torque, vertical set screw 430 may be rotated to drive gripper 420 into vertical knurl insert 410. In this manner, gripper knurl surface 425 may engage with vertical knurl surface 417 and prevent tubular members 310 and 320 from rotating out of the desired torque.

Modifications, additions, or omissions may be made to the system illustrated as connector assembly 300 without departing from the scope of the disclosure. For example, while the illustrated embodiment shows vertical set screw 430 coupling to gripper 420 using cap screw 440, vertical set screw 430 may couple to gripper 420 using any suitable mechanism. As another example, although female tubular member 310 is illustrated having vertical knurl insert 410 within vertical recessed slot 415, in some embodiments, female tubular member 310 may be designed with a knurl surface on its top surface instead of using vertical knurl insert 410.

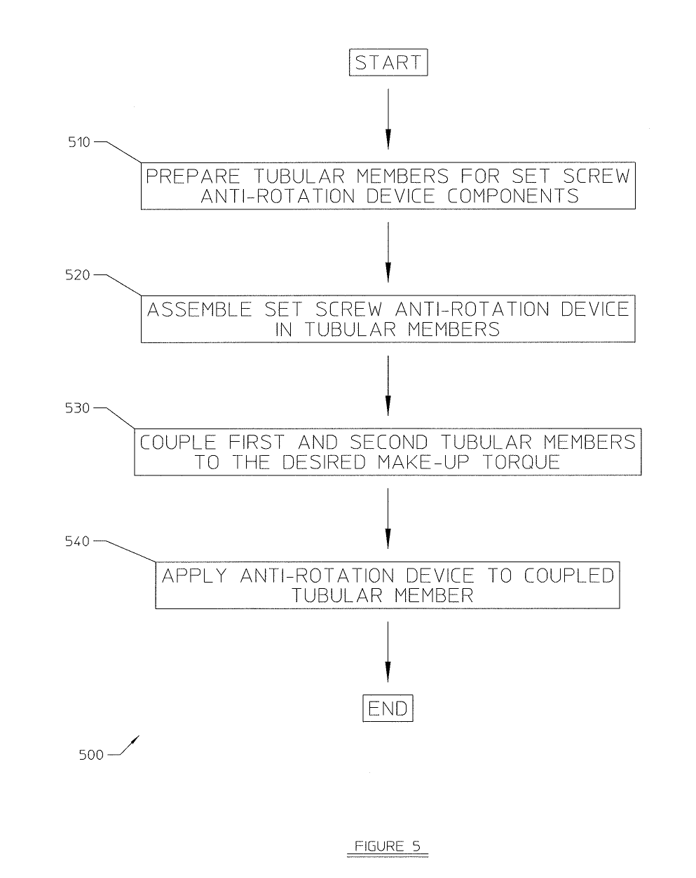

FIG. 5 illustrates a method 500 for securely coupling tubular members using a set screw anti-rotation device having a knurl surface. At step 510, the tubular members are prepared for the set screw anti-rotation device components. Preparation of the tubular members may depend on a number of factors, including whether set screw anti-rotation device is implemented using radial set screw anti-rotation device 130 or vertical set screw anti-rotation device 330.

If tubular members are prepared for radial set screw anti-rotation device 130, the inner circumference of female tubular member 110 may be milled to have recessed slot 250 and drilled and tapped to create radial threaded hole 215 extending from the outer circumference of female tubular member 110 into recessed slot 250.

If tubular members are prepared for vertical set screw anti-rotation device 330, male tubular member 320 may be milled to have blind hole 437 extending up from the bottom shoulder of male tubular member 320. The top shoulder of male tubular member 320 may be drilled and tapped to have vertical threaded hole 435 that extends into blind hole 437 located on the bottom of the shoulder of male tubular member 320. Female tubular member 310 may also be milled vertical recessed slot 415 on the top face of female tubular member 310.

At step 520, the set screw anti-rotation device may be assembled in the tubular member(s). For example, to assemble radial set screw anti-rotation device 130, insert 220 having a radially inward facing knurl surface 230 may be fitted into recessed slot 250. Once insert 220 is fixed within recessed slot 250, radial set screw 210 may be inserted into radial threaded hole 215 and coupled to insert 220. In some embodiments, radial set screw 210 may be coupled to insert 220 by using an unthreaded end of radial set screw 210 that extends through a gap in insert 220. Washer 260 and retaining ring 270 may then be attached to the portion of radial set screw 210 extending through insert 220.

To assemble vertical set screw anti-rotation device 330, vertical knurl insert 410 may be placed within vertical recessed slot 415. Within male tubular member 320, vertical set screw 430 may be threaded into vertical threaded hole 435. A socket head cap screw 440 may be inserted into vertical set screw 430 and extend into blind hole 437. Gripper 420 may be inserted through the bottom of the load shoulder of male tubular member 320 using blind hole 437. Socket head cap screw 440 may then be threaded into gripper 420, thereby mechanically coupling gripper 420 to vertical set screw 430.

At step 530, tubular members may be coupled to the desired make-up torque. The desired make-up torque of the tubular members may depend on a number of factors including the application of the tubular members, the material used to create the tubular members, and the design of the tubular members.

At step 540, once the tubular members have been coupled to the desired make-up torque, the set screw anti-rotation device may be applied to prevent the tubular members from rotating out of the desired make-up torque. For example, when using radial set screw anti-rotation device 130, an Allen wrench may radially access radial set screw 210 from the outside of female tubular member 110. By rotating radial set screw 210, insert 220 is driven into knurl outer surface 240 causing knurl surface 230 of insert 220 to grip into knurl outer surface 240 of male tubular member 120.

When using vertical set screw anti-rotation device 330, an Allen wrench may vertically access vertical set screw 430 from the outside of male tubular member 320. By rotating vertical set screw 430, gripper 420 is driven into vertical knurl insert 410 causing vertical knurl surface 417 of vertical knurl insert 410 will grip into gripper knurl surface 425 of gripper 420. After step 540, method 500 may end.

Various embodiments may perform some, all, or none of the steps described above. For example, in certain embodiments, tubular members may be prepared off-site so that the tubular members do not need to be prepared on location. Moreover, one or more steps may be repeated.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend.

Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

Illustrative embodiments of the present disclosure are described in detail herein. In the interest of clarity, not all features of an actual implementation are described in this specification. It will of course be appreciated that in the development of any such actual embodiment, numerous implementation specific decisions must be made to achieve developers' specific goals, such as compliance with system related and business related constraints, which will vary from one implementation to another. Moreover, it will be appreciated that such a development effort might be complex and time consuming, but would nevertheless be a routine undertaking for those of ordinary skill in the art having the benefit of the present disclosure. Furthermore, in no way should the following examples be read to limit, or define, the scope of the disclosure. Embodiments of the present disclosure are best understood by referring to FIGS. 1 through 5, where like numbers are used to indicate like and corresponding parts.

What is claimed is:

1. A system, comprising:
a first tubular member having a first knurl surface;
a second tubular member having a recessed slot located in the inner circumference of the second tubular member and a threaded hole from the external circumference of the second tubular member into the recessed slot;
an insert located within the recessed slot, the insert comprising a second knurl surface facing radially inward from the second tubular member;
a set screw within the threaded hole of the second tubular member, the set screw having an unthreaded end mechanically coupled to the insert; and
the set screw rotatable to drive the second knurl surface of the insert into the first knurl surface of the first tubular member.

2. The system of claim 1, wherein the unthreaded end of the set screw extends through the insert and mechanically couples the set screw to the insert using a washer and a retaining ring.

3. The system of claim 1, further comprising cord stock positioned between each end of the insert and the recessed slot, the cord stock configured to center the insert within the recessed slot.

4. The system of claim 1, wherein the first knurl surface and the second knurl surface are a straight knurl pattern, and the recessed slot has a clearance that allows the insert to move up to a width of a tooth of the straight knurl within the recessed slot.

5. The system of claim 1, wherein the first knurl surface extends 360 degrees around the circumference of the first threaded tubular.

6. The system of claim 1, wherein the insert is made of nylon.

7. The system of claim 1, wherein the set screw is further configured to be rotated in an opposite direction to remove the second knurl surface of the insert from the first knurl surface of the first tubular member.

8. The system of claim 1, wherein the first tubular member is a male pin connector and the second tubular member is a female box connector.

9. A method for securely coupling tubular members, the method comprising:
preparing a first tubular member and a second tubular member to receive a radial set screw anti-rotation device, wherein preparing the first tubular member and the second tubular member comprises:
forming a recessed slot in the inner circumference of the second tubular member;
forming a hole from the external circumference of the second tubular member into the recessed slot; and
forming the hole from the external circumference of the second tubular member into the recessed slot;
assembling the radial set screw anti-rotation device, wherein assembling the radial set screw anti-rotation device comprises:
installing an insert within the recessed slot of the second tubular member, the insert comprising a first knurl surface facing radially inward from the second tubular member; and
threading a set screw within the threaded hole of the second tubular member, the set screw having an unthreaded end mechanically coupled to the insert;
coupling the first tubular member and the second tubular member to a make-up torque; and
driving the first knurl surface of the insert into a second knurl surface of the first tubular device by rotating the insert within the tapped hole.

10. The method of claim 9, wherein mechanically coupling the unthreaded end of the set screw to the insert comprises:
attaching a washer to the unthreaded end of the set screw extending through the insert; and
attaching a retaining ring to the unthreaded end of the set screw extending through the insert.

11. The method of claim 9, further comprising:
inserting cord stock between each end of the insert and the recessed slot, the cord stock configured to center the insert within the recessed slot.

12. The method of claim 9, wherein the first knurl surface and the second knurl surface are a straight knurl pattern, and the recessed slot has a clearance that allows the insert to move up to a width of a tooth of the straight knurl within the recessed slot.

13. The method of claim 9, wherein the second knurl surface extends 360 degrees around the circumference of the first threaded tubular.

14. The method of claim 9, wherein the insert is made of nylon.

15. The method of claim 9, further comprising:
removing the first knurl surface of the insert from the second knurl surface of the first tubular device by rotating the insert within the tapped hole; and
de-coupling the first tubular member and the second tubular member.

16. The method of claim 9, wherein the first tubular member is a male pin connector and the second tubular member is a female box connector.

17. A radial set screw anti-rotation device, comprising:
an insert located within a recessed slot of a first tubular member, the recessed slot located in the inner circumference of the first tubular member and the insert having a first knurl surface facing radially inward from the first tubular member;
a set screw located within a threaded hole of the first tubular member, the threaded hole extending from the external circumference of the first tubular member into the recessed slot, wherein the set screw comprises an unthreaded end mechanically coupled to the insert; and
the set screw rotatable to drive the first knurl surface of the insert into a second knurl surface of a second tubular member, when the first tubular member and the second tubular member are coupled.

18. The radial set screw anti-rotation device of claim 17, wherein the unthreaded end of the set screw extends through the insert and mechanically couples the set screw to the insert using a washer and a retaining ring.

19. The radial set screw anti-rotation device of claim 17, further comprising cord stock positioned between each end of the insert and the recessed slot, the cord stock configured to center the insert within the recessed slot.

20. The radial set screw anti-rotation device of claim 17, wherein the first knurl surface and the second knurl surface are a straight knurl pattern, and the recessed slot has a clearance that allows the insert to move up to a width of a tooth of the straight knurl within the recessed slot.
